(19) United States
(12) Patent Application Publication
(10) Pub. No.: US 2005/0066632 A1
(43) Pub. Date: Mar. 31, 2005

(54) Horse boot with high-profile protective cuff

(76) Inventors: Garrett N. Ford, Tucson, AZ (US); Dana M. Johnsen, Pitt Meadows (CA)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/948,584

(22) Filed: Sep. 23, 2004

Related U.S. Application Data
(63) Continuation-in-part of application No. 10/755,984, filed on Jan. 13, 2004.
(63) Continuation-in-part of application No. 10/910,977, filed on Aug. 4, 2004.
Application No. 10/910,977 is a continuation-in-part of application No. 10/755,945, filed on Jan. 13, 2004.
(60) Provisional application No. 60/506,243, filed on Sep. 26, 2003.

(51) Int. Cl. B68C 5/00

(52) U.S. Cl. 54/82

(57) ABSTRACT

A horse boot includes a receiver for a hoof. The receiver has a sole, an upper on the sole and a mechanism for tightening the upper around the hoof of a horse. The boot further includes a gaiter which is attachable to the upper so as to extend around the rear of the receiver. The gaiter can be wrapped around the portion of the horse's leg immediately above the hoof and functions as a barrier against the entry of debris into the receiver.

### REFERENCE TO RELATED APPLICATION

This application is based on provisional application No. 60/506,243, filed Sep. 26, 2003, and a continuation-in-part of Ser. No. 10/755, 984, filed Jan. 13, 2004, and a continuation-in-part of Ser. No. 10/910,977, filed Aug. 4, 2004, which is a continuation-in-part of Ser. No. 10/755,945, filed Jan. 13, 2004.

### BACKGROUND OF THE INVENTION

1. Field of the Invention

The invention relates to footwear for animals.

2. Description of the Prior Art

Horse boots represent one type of footwear for animals. Such boots are used to protect the hooves and fetlocks of horses and are sometimes employed in lieu of horseshoes.

A horse boot typically consists of a sole and an upper which is secured to the sole. In most cases, the upper defines an opening at the front of the boot for a tongue. The boot is put on a horse by spreading the upper, sliding a hoof of the horse into the boot and tightening the upper around the hoof. The tongue facilitates the spreading of the upper and thus the process of inserting the hoof in the boot.

U.S. Patent No. D440,363 discloses a horse boot of this kind. Here, the upper decreases in height from the front of the boot to the back so that the rear portion of the upper is shorter than the front portion thereof. This design allows a hoof to be inserted into the boot relatively easily from the rear of the boot.

Due to the low profile of the boot at the rear, debris tends to enter and accumulate in the boot. Moreover, the low profile of the boot at the rear allows the hoof on which the boot is worn to slip out of the boot fairly readily.

### SUMMARY OF THE INVENTION

One aspect of the invention resides in footwear for an animal.

In one embodiment, the footwear comprises a support for bearing against a leg of the animal and against the ground, an enclosure on the support for enclosing at least part of the leg of the animal and a barrier for inhibiting entry of debris into the enclosure.

The barrier can be discrete from the support and the enclosure. The barrier and at least one of the support and the enclosure may then be provided with cooperating coupling elements for releasably connecting the barrier to the support and/or the enclosure. The coupling elements can include a pair of complementary elements designed for snap action. The barrier, the support and the enclosure have respective rear portions, and the rear portion of the barrier and the rear portion of at least one of the support and the enclosure may be provided with selected ones of the coupling elements.

The barrier and at least one of the support and the enclosure can be further provided with cooperating anchoring elements for anchoring the barrier on the support and/or the enclosure. These cooperating anchoring elements may comprise complementary lips.

At least one of the support and the enclosure can be provided with an urging element for urging the barrier towards the leg of the animal when the leg bears against the support. The barrier has a rear portion and the urging element is preferably arranged to urge such rear portion towards the leg of the animal when the leg bears against the support. The urging element may include or be constituted by a strap.

It is preferred for at least part of the barrier to be flexible.

The barrier can comprise overlapping layers with one of the layers serving to reinforce the other of the layers. The reinforced layer is advantageously resilient.

The enclosure may include peripheral wall means defining an opening and a tongue movable into and out of the opening. The tongue has opposed lateral edges which face the peripheral wall means and are free of attachments.

Another embodiment of the footwear comprises a support for bearing against a leg of the animal and against the ground, an enclosure on the support for enclosing at least part of the leg of the animal and a gripping element on at least one of the support and the enclosure. The gripping element has a toothed portion for gripping the leg of the animal, and this embodiment of the footwear further comprises a removable cover for the toothed portion.

In an additional embodiment, the footwear comprises a support for bearing against a leg of the animal and against the ground, an enclosure on the support for enclosing at least part of the leg of the animal, means for tightening the enclosure around the leg of the animal and means for arresting the tightening means. The arresting means can include or be constituted by a pin. The tightening means may include a buckle and the arresting means or pin can then be designed to arrest the buckle.

Different embodiments of the footwear can be used in combination.

Another aspect of the invention resides in a method of protecting a leg of an animal.

One embodiment of the method comprises the steps of placing the leg of the animal in an enclosure and against a support which is designed to bear against the ground, and inhibiting the entry of debris into the enclosure with a barrier to the debris.

This embodiment of the method can further comprise the steps of connecting the barrier to at least one of the support and the enclosure, and disconnecting the barrier from the support and/or the enclosure.

The present embodiment of the method may also comprise the step of anchoring the barrier to at least one of the support and the enclosure.

The instant embodiment of the method can additionally comprise the step of urging the barrier towards the leg of the animal with urging means discrete from the barrier.

Another embodiment of the method comprises the step of providing a support and an enclosure for the leg of the animal. The support is designed to bear against the leg of the animal and against the ground, and at least one of the support and the enclosure is provided with a gripping element having a toothed portion for gripping the leg of the animal. This embodiment of the method further comprises the steps of covering the toothed portion, and placing the leg of the animal against the support and in the enclosure.

The present embodiment of the method may also comprise the step of uncovering the toothed portion.

An additional embodiment of the method comprises the steps of placing the leg of the animal in an enclosure, tightening the enclosure around the leg of the animal using tightening means, and arresting the tightening means when the enclosure is tightened. The arresting step can involve engaging the tightening means with arresting means and the instant embodiment of the method may then comprise the step of removing the arresting means from the tightening means using a hoof pick.

Different embodiments of the method can be used in combination.

Additional features and advantages of the invention will be forthcoming from the following detailed description of preferred embodiments when read in conjunction with the accompanying drawings.

### BRIEF DESCRIPTION OF THE DRAWINGS

FIG. 1 is a side perspective view of one embodiment of animal footwear according to the invention, the footwear including a receiving part for the lowermost portion of the leg of an animal, a gaiter for an adjoining part of the leg and a buckle for tightening the receiving part.

FIG. 2 is a side perspective view of the receiving part of FIG. 1.

FIG. 3 is a front perspective view of the receiving part of FIG. 1.

FIG. 4 is a rear perspective view of the receiving part of FIG. 1.

FIG. 5 is a front elevational view of the gaiter of FIG. 1 in an open position.

FIG. 6 is a sectional view in the direction of the arrows VI-VI of FIG. 5.

FIG. 7 is a rear perspective view of the footwear of FIG. 1.

FIG. 8 is a rear view of a cover for teeth mounted inside the receiving part of the footwear of FIG. 1.

FIG. 9 is a side view of the cover of FIG. 8.

FIG. 10 is an enlarged side perspective view of another embodiment of a buckle for tightening the receiving part of the footwear of FIG. 1.

FIG. 11 is an enlarged fragmentary side perspective view of another embodiment of animal footwear according to the invention.

### DESCRIPTION OF THE PREFERRED EMBODIMENTS

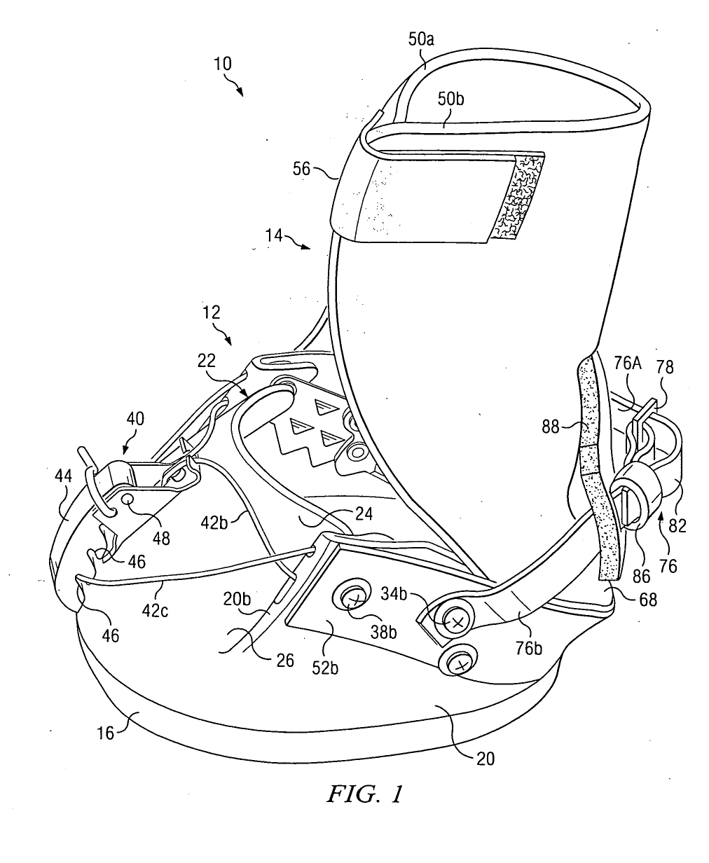

Referring to FIG. 1, the numeral 10 identifies an article of footwear which is designed in accordance with the invention and is intended to be worn by an animal. The footwear 10, which is here assumed to be a boot for use on a horse, includes a hoof receiver or hoof receiving part 12 and a gaiter or barrier 14. The hoof receiver 12, which can be made of plastic, is adapted to receive a hoof of a horse while the gaiter 14 is adapted to receive a portion of a horse's leg which is located immediately above the hoof and typically includes the pastern.

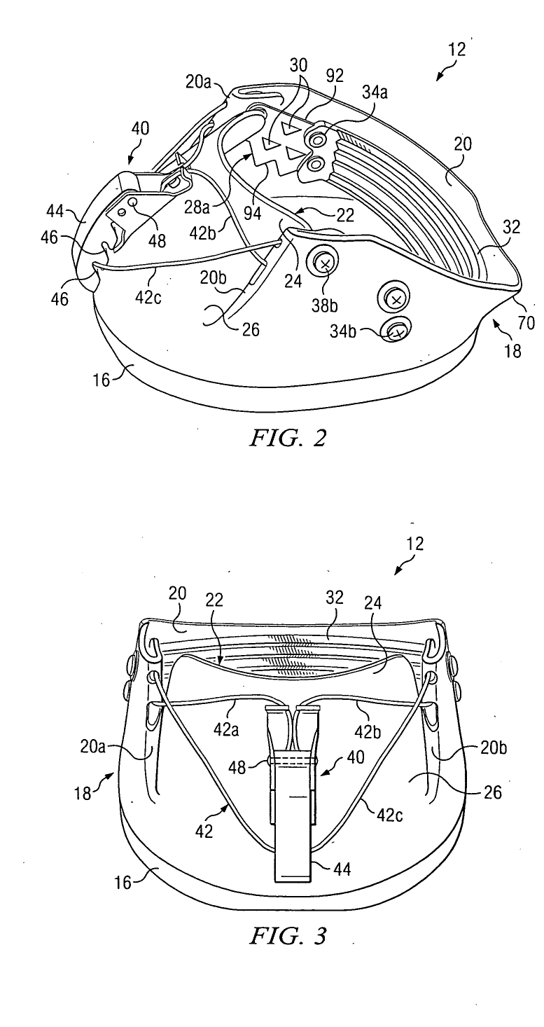

Considering FIGS. 2-4, the hoof receiver 12 comprises a rigid sole or support 16 which is arranged to bear against a hoof and against the ground. The hoof receiver 12 further comprises a semirigid upper or enclosure 18 which is adapted to surround at least part of the hoof.

The upper 18 includes a peripheral wall 20 which runs along the edge of the sole 16 and is secured to the latter in a conventional manner. The peripheral wall 20, which is here integral, defines an opening at the front of the hoof receiver 12. A tongue 22 located towards the front of the hoof receiver 12 is movable into and out of the opening, and the tongue 22 has a free end 24 which is remote from the sole 16 and faces away from the same. The tongue 22 has another end 26 which is disposed opposite the end 24 and is directed towards the sole 16, and the end 26 is situated in the opening defined by the peripheral wall 20 and is connected to the latter. Thus, the tongue 22 is of one piece with the peripheral wall 20. The end 26 of the tongue 22 serves as a pivot on which the tongue 22 can be rotated into and out of the opening defined by the peripheral wall 20.

The tongue 22 has a pair of opposed lateral edges which run between the ends 24,26 thereof. These lateral edges of the tongue 22 are located on opposite sides of the opening defined by, and face, the peripheral wall 20. Such lateral edges of the tongue 22 are free, that is, have no attachments. The lack of attachments at the lateral edges of the tongue 22 makes it easier to place a hoof in the hoof receiver 12 and also allows the upper 18 to conform to the hoof more readily.

The height of the peripheral wall 20 at the back of the hoof receiver 12 is relatively small and increases in a direction towards the front of the hoof receiver 12. The relatively small height of the peripheral wall 20 at the back of the hoof receiver 12 simplifies insertion of a hoof into the hoof receiver 12 from the rear.

The peripheral wall 20 has two spaced edges 20a and 20b which bound the opening defined by the peripheral wall 20 and face to the front of the hoof receiver 12. A gripping element or toothed element 28a is mounted internally of the peripheral wall 20 adjacent to the edge 20a while a gripping element or toothed element 28b is mounted internally of the peripheral wall 20 adjacent to the edge 20b. Each of the gripping elements 28a,28b includes a metal plate which extends rearwardly from a location near the respective edge 20a,20b of the peripheral wall 20 partway to the back of the hoof receiver 12. The metal plates are provided with triangular teeth or projections 30 which protrude to the interior of the hoof receiver 12. Each of the teeth 30 has a downwardly facing apex which is designed to penetrate and grip a hoof and thereby cause the hoof receiver 12 to sit on the hoof more firmly.

A relatively rigid band or strap 32, which may be serrated longitudinally thereof, extends from the gripping element 28a around the back of the hoof receiver 12 to the gripping element 28b. The band 32 provides a support for securing the hoof receiver 12 around the back of a hoof.

The metal plates of the gripping elements 28a,28b each have an end remote from the respective edge 20a,20b of the peripheral wall 20 and the ends of the band 32 overlap such ends of the metal plates. These ends of the metal plates are preferably sandwiched between the peripheral wall 20 and the ends of the band 32. The peripheral wall 20, the gripping element 28a and the band 32 are joined to one another by two fasteners 34a passing through the peripheral wall 20 and the overlapping ends of the gripping element 28a and the band 32. Similarly, the peripheral wall 20, the gripping element 28b and the band 32 are connected to each other by two fasteners 34b passing through the peripheral wall 20, the gripping element 28b and the overlapping ends of the gripping element 28b and the band 32. The fasteners 34a,34b, which can take various forms, are here screws.

At the edges 20a,20b of the peripheral wall 20, the peripheral wall 20 is folded over on itself to the interior of the hoof receiver 12. Thus, the peripheral wall 20 has an area of overlap 36a adjacent to the edge 20a and an area of overlap 36b adjacent to the edge 20b. The metal plates of the gripping elements 28a,28b each have an end near the respective edge 20a,20b and the areas of overlap 36a,36b extend rearwardly from the edges 20a,20b so as to overlie such ends of the metal plates. It is preferred for these ends of the metal plates to be located to the interior of the areas of overlap 36a,36b. The area of overlap 36a and the gripping element 28a are joined to one another by a fastener 38a passing through the area of overlap 36a and the superimposed end of the gripping element 28a. Likewise, the area of overlap 36b and the gripping element 28b are connected to each other by a fastener 38b passing through the area of overlap 36b and the superimposed end of the gripping element 28b. The fasteners 38a,38b are here once again screws but may take other forms.

The hoof receiver 12 is provided with means for tightening the upper 18 around a hoof. The tightening means here includes a buckle or tensioning element 40 as well as a cable or elongated drawing element 42 which can be tensioned and loosened by the buckle 40. The buckle 40, which is mounted on the tongue 22 of the upper 18 by a pair of conventional fasteners 114, comprises an operating lever 44 formed with a series of grooves 46. The lever 44 is pivotable at a pivot location 48 between a tightened or operative position illustrated in FIGS. 1-3 and non-illustrated released or inoperative positions. The lever 44 is adjacent and generally parallel to the tongue 22 in the tightened position and is swung upward from the tongue 22 in the released positions.

The cable 42 has two end portions 42a and 42b which are fixed to the tongue 22 of the upper 18. From the end portion 42a, the cable 42 runs to a first opening in the edge 20a of the peripheral wall 20 and through the first opening into the area of overlap 36a and between the respective overlapping sections of the peripheral wall 20. The cable 42 then passes around the screw 38a and out of the area of overlap 36a through a second opening provided in the edge 20a above the first opening.

Similarly, from the end portion 42b, the cable 42 extends to a first additional opening in the edge 20b of the peripheral wall 20 and through the first additional opening into the area of overlap 36b and between the respective overlapping sections of the peripheral wall 20. The cable 42 thereupon runs around the screw 38b and out of the area of overlap 36b through a second additional opening formed in the edge 20b above the first additional opening.

The screws 38a,38b serve as anchors for the cable 42.

The cable 42 has a segment 42c which is disposed centrally of the cable 42 and runs over the tongue 22 between the upper openings in the edges 20a,20b of the peripheral wall 20. When the lever 44 of the buckle 40 is in a released position, the central segment 42c can be inserted in one of the grooves 46 of the lever 44. Assuming that a hoof has been placed in the hoof receiver 12, pivoting of the lever 44 to the tightened position then tensions the cable 42 which, in turn, draws the upper 18 around the hoof.

The lever 44 is provided with several of the grooves 46 in order to allow tightening of the upper 18 around hooves of different circumference.

Referring to FIG. 5, the gaiter or barrier 14 of the horse boot 10 is here separate or discrete from the hoof receiver 12. The gaiter 14 includes a wrapping section or upper section 50, a mounting section or lower section 52 and a connecting section or intermediate section 54 which joins the wrapping section 50 and the mounting section 52 to one another. The connecting section 54 has a width smaller than that of the wrapping section 50 and smaller than that of the mounting section 52 so that two flaps 50a and 50b are formed on the wrapping section 50 and two flaps 52a and 52b are formed on the mounting section 52. Preferably, at least the wrapping section 50 is flexible.

The wrapping section 50 is adapted to be wrapped around a leg of a horse. In order to secure the wrapping section 50 around a horse's leg, the flap 50b of the wrapping section 50 is provided with a flexible strap 56. The strap 56 and the flap 50a are formed with non-illustrated coupling means for releasably connecting the flap 50a and the flap 50b to one another. The coupling means may take different forms although it is currently preferred for the coupling means to be constituted by a hook-and-loop fastener.

The mounting section 52 of the gaiter 14 is designed to be attached to the upper 18 of the horse boot 10. To this end, the flap 52a of the mounting section 52 is provided with two holes 58a which can be aligned with the two screws 34a of the hoof receiver 12. The flap 52a is further provided with a hole 60a which is arranged to be aligned with the screw 38a of the hoof receiver 12. Similarly, the flap 52b of the mounting section 52 is formed with two holes 58b which are designed to be aligned with the two screws 34b of the hoof receiver 12. In addition, the flap 52b is formed with a hole 60b which can be aligned with the screw 38b of the hoof receiver 12.

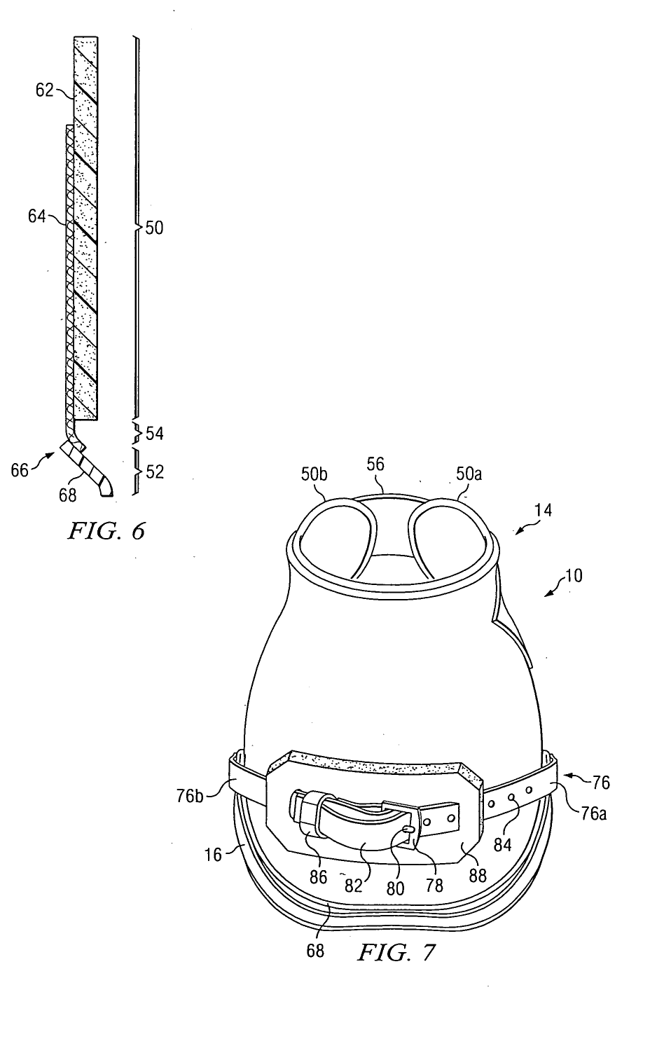

Considering FIG. 6 together with FIG. 5, the gaiter 14 includes a bearing layer or member 62 which is adapted to lie against a leg of a horse and partially constitutes the wrapping section 50. The gaiter 14 further includes a reinforcing layer or member 64 which overlaps, and supports and reinforces, the bearing layer 62. The reinforcing layer 64 forms part of the wrapping section 50 and part of the mounting section 52 and also constitutes the connecting section 54. The bearing layer 62 projects above the reinforcing layer 64 while the reinforcing layer 64 projects below, and has an edge beneath and spaced from, the bearing layer 62. This edge of the reinforcing layer 64 is attached to a carrying member 66 which constitutes the major part of the mounting section 52 and carries the layers 62,64. The carrying member 66 defines a lip or protrusion 68 at the lower end of the gaiter 14.

The bearing layer 62 of the gaiter 14 is flexible and preferably resilient. By way of example, the bearing layer 62 may be made of neoprene. The reinforcing layer 64 is advantageously flexible and should be stronger and more resistant to wear than the bearing layer 62. Suitable materials for the reinforcing layer 64 include leather as well as textiles made from natural and/or synthetic substances. The carrying member 66 can be semirigid or rigid and can, for instance, be composed of plastic.

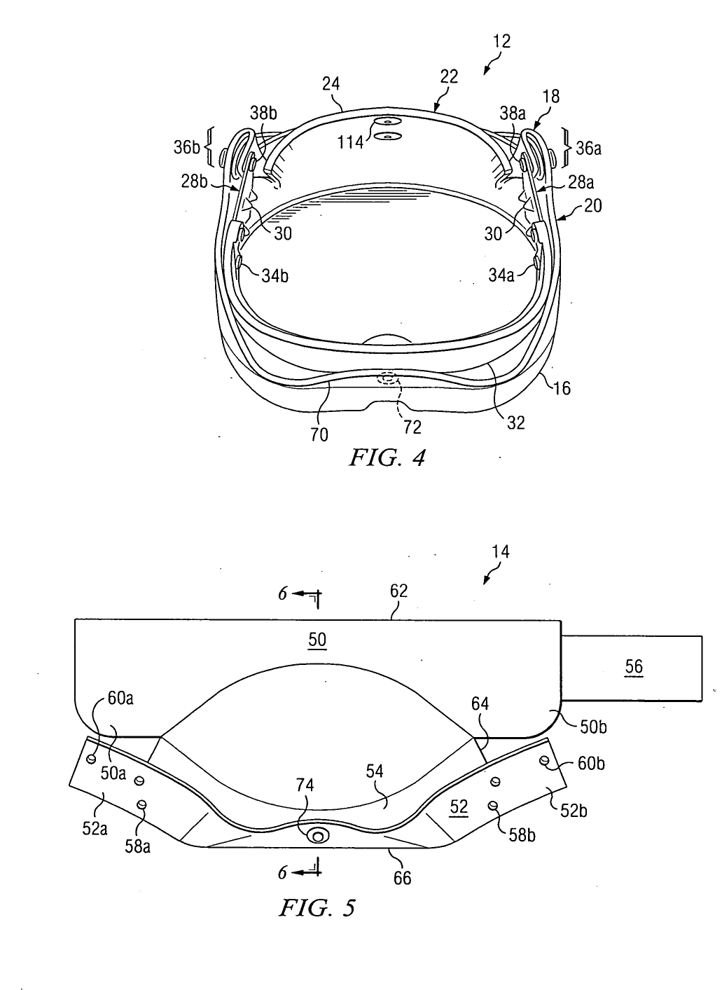

Turning to FIGS. 2 and 4 in conjunction with FIGS. 5 and 6, one manner of mounting the gaiter 14 on the hoof receiver 12 will be described.

The gaiter 14 is arranged with the lip 68 of the carrying member 66 at the rear of and facing the hoof receiver 12. As seen in FIGS. 2 and 4, the peripheral wall 20 of the upper 18 defines a lip or overhang 70 at the rear of the hoof receiver 12, and the lip 68 of the gaiter 14 is positioned underneath the lip 70 of the hoof receiver 12. The screws 34a of the hoof receiver 12 are removed exposing two non-illustrated passages which run through the peripheral wall 20 of the upper 18 and through the gripping element 28a. The flap 52a of the carrying member 66 is placed adjacent to the outer surface of the peripheral wall 20 on that side of the hoof receiver 12 with the gripping element 28a and the holes 58a in the flap 52a are respectively aligned with the exposed passages. The screws 34a are then inserted in the holes 58a and the registering passages to partially attach the flap 52a to the hoof receiver 12. Subsequently, the screw 38a of the hoof receiver 12 is removed exposing another non-illustrated passage which extends through the peripheral wall 20 and the gripping element 28a, and the hole 60a in the flap 52a is aligned with this passage. The screw 38a is thereupon inserted in the hole 60a and the registering passage to complete attachment of the flap 52a to the hoof receiver 12.

Once the flap 52a of the carrying member has been secured to the hoof receiver 12, the screws 34b of the hoof receiver 12 are removed exposing two non-illustrated passages which run through the peripheral wall 20 of the upper 18 and through the gripping element 28b. The flap 52b of the carrying member 66 is placed adjacent to the outer surface of the peripheral wall 20 on that side of the hoof receiver 12 with the gripping element 28b and the holes 58b in the flap 52b are respectively aligned with the exposed passages. The screws 34b are then inserted in the holes 58b and the registering passages to partially attach the flap 52b to the hoof receiver 12. Subsequently, the screw 38b of the hoof receiver 12 is removed exposing another non-illustrated passage which extends through the peripheral wall 20 and the gripping element 28b, and the hole 60b in the flap 52b is aligned with this passage. The screw 38b is thereupon inserted in the hole 60b and the registering passage to complete attachment of the flap 52b to the hoof receiver 12.

The lip 68 of the gaiter 14 lies underneath and confronts the lip 70 of the hoof receiver 12, and the lips 68,70 prevent the gaiter 14 from being pulled upward when the gaiter 14 surrounds a leg of a horse. Thus, the lips 68,70 may be considered to constitute cooperating anchoring elements for anchoring the gaiter 14 to the hoof receiver 12.

When the horse boot 10 is mounted on a leg of a horse, the horse boot 10 serves to protect the leg. One manner of mounting the horse boot 10 on, and removing the horse boot 10 from, the leg is described below.

Assuming that the lever 44 of the buckle 40 is in a released position and that the strap 56 of the gaiter 14 is disconnected from the flap 50a, the tongue 22 of the hoof receiver 12 is pulled forward and the peripheral wall 20 is spread apart. The flaps 50a,50b of the gaiter 14 are pulled away from one another and the hoof of the leg to be protected is lifted and placed inside the hoof receiver 12 by moving the hoof past the gaiter 14. The hoof is positioned on the sole 16 of the hoof receiver 12 with the back of the hoof against the band 32, and the tongue 22 and peripheral wall 20 are pushed towards the hoof. The central segment 42c of the cable 42 is placed in an appropriate one of the grooves 46 of the lever 44 and the lever 44 is pivoted to the tightened position. This action tensions the cable 42 and draws the tongue 22 and the peripheral wall 20 towards the hoof so that the hoof lies snugly against the tongue 22, the gripping elements 28a,28b and the band 32.

Once the hoof receiver 12 has been fastened on the hoof, the flaps 50a,50b of the gaiter 14 are pulled around and snugly against the portion of the horse's leg immediately above the hoof. The strap 56 of the gaiter 14 is then secured to the flap 50a thereby fixing the gaiter 14 on the horse's leg.

The gaiter 14 serves as a barrier which inhibits the entry of debris into the hoof receiver 12. Furthermore, should the buckle 40 release, the gaiter 14 can prevent the hoof receiver 12 from falling off the hoof.

To remove the horse boot 10 from the horse's leg, the strap 56 of the gaiter 14 is released from the flap 50a and the flaps 50a,50b are pulled away from each other. The lever 44 of the buckle 40 is then moved to a released position thereby loosening the cable 42. The tongue 22 of the hoof receiver 12 is thereupon pulled forward while the peripheral wall 20 is spread apart to free the hoof from the grip of the hoof receiver 12. The hoof is now lifted from the receiver 12.

Should it be necessary or desirable to disconnect the gaiter 14 from the hoof receiver 12, e.g., for replacement of the gaiter 14, this may be readily accomplished. One manner of disconnecting the gaiter 14 from the hoof receiver 12 is described below.

The screw 38b is removed exposing the hole 60b in the flap 52b of the gaiter 14 as well as the non-illustrated registering passage running through the peripheral wall 20 of the upper 18 and through the gripping element 28b of the hoof receiver 12. The portion of the flap 52b with the hole 60b is pulled away from the peripheral wall 20 and the screw 38b is reinserted in the exposed passage. Subsequently, the screws 34b are removed to expose the holes 58b in the flap 52b and the non-illustrated registering passages in the peripheral wall 20 and the gripping element 28b. The flap 52b is pulled rearward and the screws 34b are reinserted in the respective exposed passages.

Following release of the flap 52b from the hoof receiver 12, the screw 38a is removed to expose the hole 60a in the flap 52a of the gaiter 14 and also the non-illustrated registering passage extending through the peripheral wall 20 of the upper 18 and through the gripping element 28a of the hoof receiver 12. The portion of the flap 52a with the hole 60a is pulled away from the peripheral wall 20 and the screw 38a is reinserted in the exposed passage. The screws 34a are thereupon removed to expose the holes 58a in the flap 52a and the non-illustrated registering passages in the peripheral wall 20 and the gripping element 28a. The gaiter 14 is then pulled away from the hoof receiver 12 and the screws 34a reinserted in the respective exposed passages.

The screws 34a,34b,38a,38b of the hoof receiver 12 and the holes 58a,58b,60a,60b of the gaiter 14 can be considered to constitute cooperating coupling elements for releasably connecting the gaiter 14 to the hoof receiver 12.

Although the gaiter 14 is here releasably connected to the hoof receiver 12 by way of the screws 34a,34b,38a,38b, other releasable connections between the gaiter 14 and the hoof receiver 12 can be employed. For example, a tongue-and-groove connection or a ball-and-socket joint, as well as snaps or hook-and-loop fasteners, may be used to releasably connect the gaiter 14 to the hoof receiver 12.

Instead of releasably connecting the gaiter 14 to the hoof receiver 12, it is possible to permanently attach the gaiter 14 to the receiver 12. By way of example, the gaiter 14 may be integrally molded into the peripheral wall 20 of the hoof receiver 12 or attached to the hoof receiver 12 with rivets or adhesive.

The height of at least that portion of the gaiter 14 situated at the rear of the hoof receiver 12 is advantageously about 6 inches.

Referring to FIGS. 4 and 5, the rearwardly facing surface of the peripheral wall 20 of the upper 18 can be provided with a male or female portion 72 of a snap while the surface of the gaiter 14 which confronts the rearwardly facing surface of the peripheral wall 20 can be provided with a complementary portion 74 of the snap. The snap portion 72 of the peripheral wall 20 is preferably centered widthwise of the hoof receiver 12 while the snap portion 74 of the gaiter 14, which may be fixed to the mounting section 52 and/or the connecting section 54 of the gaiter 14, is advantageously centered widthwise of the mounting section 52 and the connecting section 54.

The snap 72,74 functions to secure the portion of the gaiter 14 located at the rear of the hoof receiver 12 to the latter. The snap portions 72,74 can be considered to constitute cooperating coupling elements for releasably connecting the gaiter 14 to the hoof receiver 12.

Considering FIGS. 1 and 7, the horse boot 10 may be provided with a strap or elongated urging element 76 which is adapted to run around the rear of the gaiter 14. The strap 76 here comprises two discrete portions 76a and 76b each having two longitudinal ends. One of the longitudinal ends of the strap portion 76b carries a buckle 78 with a catch 80 while the other longitudinal end of the strap portion 76b is formed with a non-illustrated hole. Similarly to the strap portion 76b, one of the longitudinal ends of the strap portion 76a is formed with a non-illustrated hole. The other longitudinal end of the strap portion 76a constitutes a tongue 82, and the strap portion 76a is provided with a straight row of openings 84 between the tongue 82 and the non-illustrated hole at the other longitudinal end of the strap portion 76a. The openings 84 are designed to receive and arrest the catch 80 of the buckle 78, and the strap 76 can be tightened and loosened to varying degrees by inserting the catch 80 in different ones of the openings 84.

The non-illustrated hole in the strap portion 76a allows the strap portion 76a to be releasably connected to the hoof receiver 12 and the gaiter 14 by way of one of the screws 34a,38a of the hoof receiver 12. Likewise, the non-illustrated hole in the strap portion 76b makes it possible for the strap portion 76b to be releasably connected to the hoof receiver 12 and the gaiter 14 via one of the screws 34b,38b of the hoof receiver 12. The strap portion 76a is here held on the hoof receiver 12 and the gaiter 14 by one of the screws 34a whereas the strap portion 76b is held on the hoof receiver 12 and the gaiter 14 by the corresponding screw 34b. The screw 34a holding the strap portion 76a extends through the non-illustrated hole in the strap portion 76a, and this hole is aligned with the respective hole 58a in the flap 52a of the gaiter 14 and with the registering non-illustrated passage running through the peripheral wall 20 of the upper 18 and through the gripping element 28a of the hoof receiver 12. On the other hand, as indicated in FIG. 1, the screw 34b holding the strap portion 76b passes through the non-illustrated hole in the strap portion 76b, and such hole is in alignment with the respective hole 58b in the flap 52b of the gaiter 14 and with the registering non-illustrated passage extending through the peripheral wall 20 of the upper 18 and through the gripping element 28b of the hoof receiver 12.

Means other than the screws 34a,34b,38a,38b may be employed to releasably connect the strap portions 76a,76b to the hoof receiver 12 and the gaiter 14.

The strap portion 76b is provided with a loop 86 which can receive the tongue of the strap portion 76a when the strap 76 is buckled. The loop 86 is designed to confine the tongue 82 so that the latter does not interfere with the movement of a horse. In addition, confinement of the tongue 82 reduces the likelihood that the strap 76 will loosen unintentionally since such confinement makes it more difficult for the catch 80 to withdraw from an opening 84 which receives the same.

The strap 76, which urges the gaiter 14 towards a leg of an animal, is preferably arranged to tighten around the upper rear part of a hoof near the fetlock. The strap 76 functions not only to hold the gaiter 14 on a leg of a horse more firmly but also to further decrease the risk of the hoof receiver 12 falling off should the hoof slip out of the hoof receiver 12.

As illustrated in FIGS. 1 and 7, a pad 88 can be disposed to the rear of the gaiter 14. The pad 88 is elongated widthwise of the horse boot 10 and has two longitudinal ends. A slot is formed in the pad 88 at each longitudinal end thereof, and the strap portion 76a passes through one of the slots while the strap portion 76b passes through the other of the slots. Accordingly, the strap portions 76a,76b support the pad 88 on the horse boot 10.

The tongue 82 of the strap portion 76a, as well as the buckle 78, the catch 80 and the loop 86 of the strap portion 76b, are all located between the slots in the pad 88 and on the side of the pad 88 facing away from the gaiter 14. Thus, the pad 88 separates the gaiter 14 from the tongue 82, the buckle 78, the catch 80 and the loop 86. The pad 88 reduces the likelihood of injury to a horse by rubbing and can make the horse more comfortable.

The pad 88 can be resilient and may, for example, be composed of an expandable or foamed material.

The teeth 30 of the gripping elements 28a,28b will typically leave marks in a hoof when allowed to grip the hoof. Since some people consider such marks unsightly, a removable cover may be provided for each of the gripping elements 28a,28b in order to prevent the teeth 30 from coming into contact with a hoof.

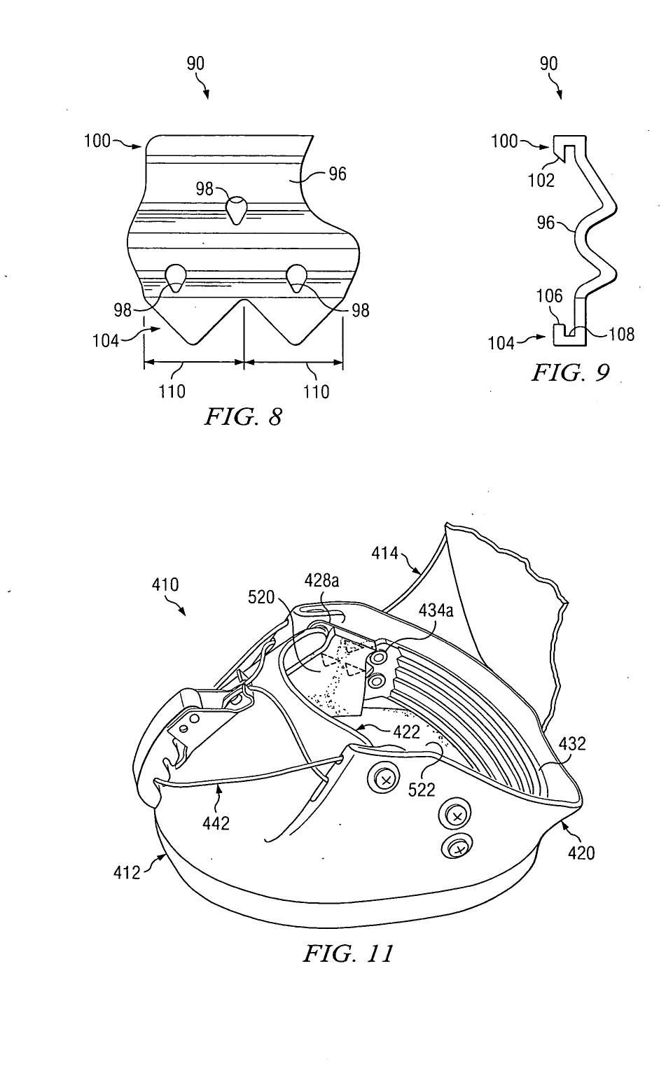

FIGS. 8 and 9 illustrate a removable cover 90 for the gripping element 28a. Inasmuch as the cover for the gripping element 28b is here assumed to be identical to the cover 90, the cover for the gripping element 28b is neither shown nor described.

Considering FIG. 2 together with FIGS. 8 and 9, the gripping element 28a has three teeth 30 arranged so that two of the teeth 30 sit next to one another below the third of the teeth 30. The metal plate of the gripping element 28a has a straight uppermost section 92 above the upper tooth 30, and the metal plate additionally has two adjoining triangular protrusions 94 which project below respective ones of the lower teeth 30. The straight section 92 and each of the protrusions 94 is spaced from the peripheral wall 20 of the upper 18 by a small non-illustrated gap. The straight section 92 is relatively narrow and has a top edge which is located slightly above the upper tooth 30.

The cover 90 has a flat surface 96 which is adapted to face the gripping element 28a, and the surface 96 is provided with three triangular recesses 98 having the same spacing and arrangement as the teeth 30 of the gripping element 28a. The dimensions of the recesses 98 are such that the recesses 98 can receive the respective teeth 30 with a light friction fit.

The cover 90 further includes a protuberance 100 which projects beyond the flat surface 96 of the cover 90. The protuberance 100 is situated adjacent to the recess 98 for the upper tooth 30 of the gripping element 28a and is formed with a straight lip 102. The cover 90 also includes a protuberance 104 which projects beyond the flat surface 96, and the protuberance 104 is located adjacent to the two recesses 98 for the lower teeth 30 of the gripping element 28a. The protuberance 94 is formed with a lip 106 and an adjacent abutment surface 108. The protuberance 104, the lip 106 and the abutment surface 108 all have a contour corresponding to that defined by the adjoining triangular protrusions 94 which project below the lower teeth 30 of the gripping element 28a. Thus, the protuberance 104, the lip 106 and the abutment surface 108 can each be considered to be made up of two adjoining triangular parts. This is indicated in FIG. 8 where the cover 90 is shown as having two adjoining triangular sections 110 each of which corresponds to one of the triangular protrusions 94 and defines a triangular part of the protuberance 104, the lip 106 and the abutment surface 108.

One manner of mounting the cover 90 on the gripping element 28a is outlined below.

The cover 90 is positioned with the flat surface 96 thereof facing the gripping element 28a. The lip 106 of the protuberance 104 is located slightly below the triangular protrusions 94 of the gripping element 28a while the lip 102 of the protuberance 100 is located opposite or nearly opposite the straight uppermost section 92 of the gripping element 28a.

The lip 106 of the protuberance 104 is pressed against the peripheral wall 20 of the upper 18 at a location immediately below the triangular protrusions 94 of the gripping element 28a and the triangular sections 110 of the cover 90 are brought into alignment with respective ones of the protrusions 94. The lip 106 is now slid upward along the peripheral wall 20 so that the triangular sections 110 enter the respective gaps between the peripheral wall 20 and the triangular protrusions 94. Upward movement of the lip 106 is continued until the abutment surface 108 of the protuberance 104 contacts the protrusions 94. At this time, the recesses 98 in the cover 90 are substantially in register with the respective teeth 30 of the gripping element 28a. The cover 90 is thereupon pressed against the gripping element 28a to cause the teeth 30 to enter the corresponding recesses 98. The lip 102 of the protuberance 100 is snapped over the top edge of the straight section 92 of the gripping element 28a thereby allowing the lip 102 to enter the gap between the straight section 92 and the peripheral wall 20 of the upper 18. The cover 90 is now securely mounted on the gripping element 28a.

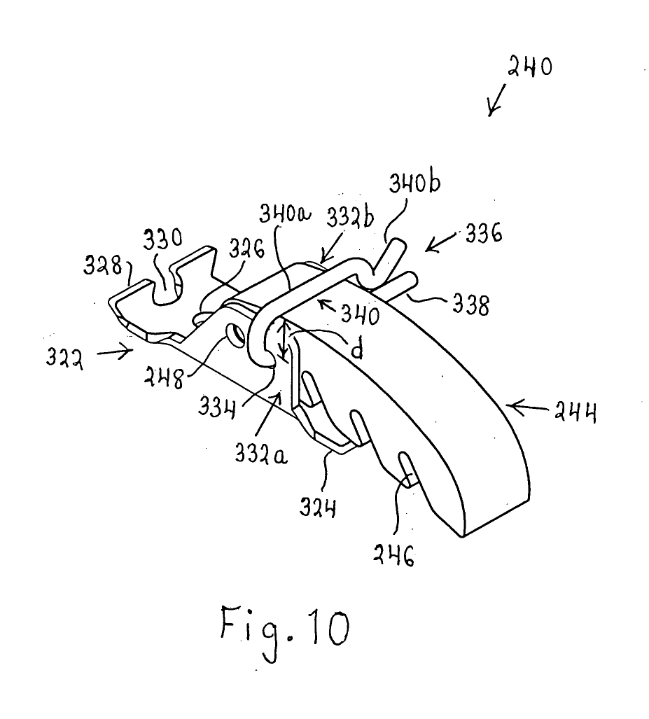

FIG. 10 illustrates another embodiment of a buckle for tightening the upper 18 of the horse boot 10 around a hoof of a horse. In FIG. 10, the same reference numerals as in the preceding FIGURES, plus 200, identify corresponding elements.

Referring to FIG. 3 in conjunction with FIG. 10, the buckle 240 of FIG. 10 includes a base 322 having an elongated flat section 324 adapted to be secured to the tongue 22 of the horse boot 10. To this end, the flat base section 324 is formed with two openings 326 for fasteners. Only one of the openings 326 is visible in FIG. 10. The flat base section 324 is provided with an additional non-illustrated opening between the two openings 326 for the fasteners, and this additional opening allows the end portions 42a,42b of the cable 42 to pass through the flat base section 324 for attachment to the tongue 22.

The flat base section 324 has opposed longitudinal ends, and two ears 328 project to one side of the flat base section 324 at one of these ends. The ears 328 are separated from one another by a passage 330 for the end portions 42a,42b of the cable 42, and the ears 328 function to guide the end portions 42a,42b.

The flat base section 324 further has opposite longitudinal edges, and a flange 332a projects from one of these edges while a flange 332b projects from the other of these edges. The flanges 332a,332b project to the same side of the flat base section 324 as the ears 328. The flanges 332a,332b are located directly opposite, and are parallel to, one another, and the flanges 332a,332b are spaced from each other by a gap. The width of the gap between the flanges 332a,332b is slightly greater than the width of the operating lever 244 of the buckle 240.

The operating lever 244 of the buckle 240 is elongated and has opposed longitudinal ends. One such end is located in the gap between the flanges 332a,332b, and this end of the lever 244 is pivotally mounted on the flanges 332a,332b at the pivot location 248.

Each of the flanges 332a,332b is provided with a hole 334 of which only one is visible in FIG. 10, and the holes 334 are in register with each other. The lever 244 is formed with a non-illustrated passage near the pivotally mounted end thereof, and the passage is arranged to be in alignment with the holes 334 when the lever 244 is in the tightened or operative position shown in FIG. 10.

An approximately U-shaped locking or arresting pin 336 serves to lock or arrest the lever 244 in the tightened position. The locking pin 336 has a straight leg 338 and another leg 340 which includes a straight part 340a and a v-shaped free end portion 340b. The straight part 340a of the leg 340 is parallel to the straight leg 338 and is spaced therefrom by a gap. The width of the gap slightly exceeds the distance “d”, as measured with the lever 244 in the tightened position and in a plane normal to the flat section 324 of the base 322 and bisecting the holes 334 in the flanges 332a,332b, between a hole 334 and the surface of the lever 244 facing away from the base 322. The v-shaped end portion 340b of the leg 340 is oriented in such a manner that the apex of the end portion 340b confronts the straight leg 338 and is separated from the latter by a gap substantially smaller than that between the straight leg 338 and the straight part 340a of the leg 340.

The locking pin 336 is resilient so that the legs 338,340 can be pulled apart and then return to their original relative position when released.

The straight leg 338 of the locking pin 336 is receivable in the holes 334 of the flanges 332a,332b, as well as in the non-illustrated passage of the lever 244, with a small amount of clearance. Moreover, the length of the straight part 340a of the leg 340 exceeds the distance between the outwardly facing surfaces of the flanges 332a,332b.

One manner of arresting the lever 244 in the tightened position is outlined below.

The leg 340 of the locking pin 336 is forced away from the straight leg 338 so that the distance between the straight leg 338 and the apex of the v-shaped end portion 340b of the leg 340 equals or exceeds the distance “d”. This allows the straight leg 338 to enter the hole 334 in the flange 332a and pass through this hole 334 into the registering non-illustrated passage of the lever 244. The straight leg 338 is then pushed through the non-illustrated passage of the lever 244 and through the hole 334 in the flange 332b. During travel of the straight leg 338 through the non-illustrated passage in the lever 244, the apex of the v-shaped end portion 340b of the leg 340 moves from the flange 332a towards the flange 332b and can be allowed to slide in this direction on the surface of the lever 244 facing away from the base 322. After the straight leg 338 has passed through the hole 334 in the flange 332b, the v-shaped end portion 340b passes over the flange 332b. Once the v-shaped end portion 340b has moved beyond the flange 332b, the v-shaped end portion 340b returns to its original position thereby confining the lever 244 between the straight leg 338 and the straight portion 340a of the leg 340. The lever 244 is now locked in the tightened position.

To release the lever 244 from the tightened position, the leg 340 of the locking pin 336 is forced away from the straight leg 338 so that the distance between the straight leg 338 and the apex of the v-shaped end portion 340b of the leg 340 equals or exceeds the distance “d”. This enables the straight leg 338 to be pulled from the hole 334 in the flange 332b, through the registering non-illustrated passage in the lever 244 and out of the hole 344 in the flange 332a. During withdrawal of the straight leg 338 from the holes 334 and the registering non-illustrated passage in the lever 244, the apex of the v-shaped end portion 340b of the leg 340 moves from the flange 332b towards the flange 332a and may be permitted to slide in this direction on the surface of the lever 244 facing away from the base 322. As the straight leg 338 is withdrawn from the non-illustrated passage in the lever 244 and from the hole 334 in the flange 332a, the v-shaped end portion 340b passes over the flange 332a and returns to its original position after moving beyond the same. The lever 244 is released once the straight leg 338 leaves the non-illustrated passage in the lever 244.

Removal of the locking pin 336 from the buckle 240 can be accomplished by means of a hoof pick. Such a pick, which is used to remove stones and other debris lodged in the hooves of horses, generally forms part of the equipment employed by a rider of a horse.

The locking pin 336 is designed to prevent unintentional loosening of the upper 18 of the horse boot 10.

FIG. 11 shows another embodiment of a horse boot in accordance with the invention and the same numerals as in the preceding FIGURES, plus 400, identify corresponding elements.

The horse boot 410 of FIG. 11 is provided with an insert or pad 520 internally of the hoof receiver 412, and the insert 520 extends from the screws 434a of the hoof receiver 412 towards the front of the horse boot 410. The insert 520 lies against and is secured to the gripping element 428a as well as the peripheral wall 420 of the hoof receiver 412. Similarly to the teeth 30 of the horse boot 10, each of the teeth 430 of the horse boot 410 has a downwardly facing apex arranged to penetrate and grip a hoof, and the insert 520 is designed to cover at least these downwardly facing apices of the teeth 430.

The insert 520, which can be deemed to constitute a protective layer, is capable of performing several functions. To begin with, the insert 520 serves as a seal to inhibit the entry of debris into the hoof receiver 412. Moreover, in the case of a narrow hoof, the insert 520 can help fit the hoof receiver 412 to the hoof. In addition, the insert 520 prevents the teeth 430 of the gripping element 428a from penetrating a hoof. These teeth 430 will typically leave marks in a hoof when allowed to penetrate the hoof and some people consider such marks unsightly. The insert 520 makes it possible to avoid the tooth marks left behind when the teeth 430 of the gripping element 428a engage a hoof. The insert 520 can also function as padding for a hoof.

The insert 520 is advantageously resilient and may, for instance, be made of an expandable or foamed material. When made of an expandable or foamed material, the insert 520 has the ability to be compressed during use.

The hoof receiver 412 has a second gripping element which is not illustrated and corresponds to the gripping element 28b of the horse boot 10. A second and non-illustrated insert or pad similar to the insert 520 is mounted inside the hoof receiver 412 adjacent to this second gripping element. The second insert performs the same functions as the insert 520.

An additional and non-illustrated insert or pad similar to the insert 520 may be secured to the inner surface of the tongue 422 of the hoof receiver 412.

The horse boot 410 has a non-illustrated sole, and an insert or pad 522, which maybe composed of the same material as the insert 520 or of a similar material, is disposed internally of the hoof receiver 412 on such sole. The insert 522, which is secured to the sole of the horse boot 410, is intended to produce a suction seal inside the hoof receiver 412.

Except for the inserts 520,522 and the two non-illustrated inserts, the horse boot 410 is identical to the horse boot 10.

Various modifications are possible within the meaning and range of equivalence of the appended claims.

1. Footwear for an animal comprising:
a support for bearing against a leg of the animal and against the ground;
an enclosure on said support for enclosing at least part of the leg of the animal; and
a barrier for inhibiting entry of debris into said enclosure.

2. The footwear of claim 1, wherein said barrier is discrete from said support and said enclosure.

3. The footwear of claim 2, wherein said barrier and at least one of said support and said enclosure are provided with cooperating coupling elements for releasably connecting said barrier to said at least one of said support and said enclosure.

4. The footwear of claim 3, wherein said barrier, said support and said enclosure have respective rear portions, the rear portion of said barrier and the rear portion of at least one of said support and said enclosure being provided with selected ones of said coupling elements.

5. The footwear of claim 3, wherein said coupling elements comprise a pair of complementary elements designed for snap action.

6. The footwear of claim 1, wherein said barrier and at least one of said support and said enclosure are provided with cooperating anchoring elements for anchoring said barrier on said at least one of said support and said enclosure.

7. The footwear of claim 6, wherein said cooperating anchoring elements comprise complementary lips.

8. The footwear of claim 1, wherein at least one of said support and said enclosure is provided with an urging element for urging said barrier towards the leg of the animal when the leg bears against said support.

9. The footwear of claim 8, wherein said urging element comprises a strap.

10. The footwear of claim 8, wherein said barrier has a rear portion and said urging element is arranged to urge said rear portion towards the leg of the animal when the leg bears against said support.

11. The footwear of claim 1, wherein at least part of said barrier is flexible.

12. The footwear of claim 11, wherein said barrier comprises overlapping layers, one of said layers reinforcing the other of said layers.

13. The footwear of claim 12, wherein said other layer is resilient.

14. The footwear of claim 1, wherein said enclosure comprises peripheral wall means defining an opening, and a tongue movable into and out of said opening, said tongue having opposed lateral edges which face said peripheral wall means and are free.

15. The footwear of claim 1, further comprising a gripping element, having a toothed portion for gripping the leg of the animal, on at least one of said support and said enclosure, and a removable cover for said toothed portion.

16. The footwear of claim 1, further comprising means for tightening said enclosure around the leg of the animal, and means for arresting said tightening means.

17. The footwear of claim 16, wherein said arresting means comprises a pin.

18. The footwear of claim 17, wherein said tightening means comprises a buckle and said pin is designed to arrest said buckle.

19. Footwear for an animal comprising:
a support for bearing against a leg of the animal and against the ground;
an enclosure on said support for enclosing at least part of the leg of the animal;
a gripping element, having a toothed portion for gripping the leg of the animal, on at least one of said support and said enclosure; and
a removable cover for said toothed portion.

20. Footwear for an animal comprising:
a support for bearing against a leg of the animal and against the ground;
an enclosure on said support for enclosing at least part of the leg of the animal;
means for tightening said enclosure around the leg of the animal; and
means for arresting said tightening means.

21. The footwear of claim 20, wherein said arresting means comprises a pin.

22. The footwear of claim 21, wherein said tightening means comprises a buckle and said pin is designed to arrest said buckle.

23. A method of protecting a leg of an animal comprising the steps of:
placing the leg of the animal in an enclosure and against a support which is designed to bear against the ground; and
inhibiting the entry of debris into said enclosure with a barrier to the debris.

24. The method of claim 23, further comprising the steps of connecting said barrier to at least one of said support and said enclosure, and disconnecting said barrier from said at least one of said support and said enclosure.

25. The method of claim 23, further comprising the step of anchoring said barrier to at least one of said support and said enclosure.

26. The method of claim 23, further comprising the step of urging said barrier towards the leg of the animal with urging means discrete from said barrier.

27. The method of claim 23, wherein at least one of said support and said enclosure is provided with a gripping element having a toothed portion for gripping the leg of the animal; and further comprising the step of covering said toothed portion prior to the placing step.

28. The method of claim 23, further comprising the steps of tightening said enclosure around the leg of the animal using tightening means, and arresting said tightening means when said enclosure is tightened.

29. A method of protecting a leg of an animal comprising the steps of:
providing a support and an enclosure for the leg of the animal, said support being designed to bear against the leg of the animal and against the ground, and at least one of said support and said enclosure being provided with a gripping element having a toothed portion for gripping the leg of the animal;
covering said toothed portion; and
placing the leg of the animal against said support and in said enclosure.

30. The method of claim 30, further comprising the step of uncovering said toothed portion.

31. A method of protecting a leg of an animal comprising the steps of:
placing the leg of the animal in an enclosure;
tightening said enclosure around the leg of the animal using tightening means; and
arresting said tightening means when said enclosure is tightened.

32. The method of claim 31, wherein the arresting step comprises engaging said tightening means with arresting means; and further comprising the step of removing said arresting means from said tightening means using a hoof pick.
